(19) United States
(12) Patent Application Publication
(10) Pub. No.: US 2004/0074884 A1
(43) Pub. Date: Apr. 22, 2004

(54) Method and apparatus for improved lift-start welding

(75) Inventors: Brian K. Butler, Escondido, CA (US); Gennadiy Dombrovskiy, San Diego, CA (US)

Correspondence Address: GARY L. EASTMAN, 707 BROADWAY STREET, SUITE 1800, SAN DIEGO, CA, 92101, US

(73) Assignee: SSCO Manufacturing, Inc., a California Corporation

(21) Appl. No.: 10/273,827

(22) Filed: Oct. 17, 2002

(51) Int. Cl. B23K 9/06

(52) U.S. Cl. 219/130.4; 219/124.01

(57) ABSTRACT

An apparatus for initiating a welding arc during a welding process includes a power circuit to provide a welding power to a power output, a background circuit to provide a background power to the power output to maintain the welding arc during the arc-starting process, and a controller. The background circuit provides a background voltage to the power output of the welding device and detects when the motion control device has touched the electrode to the workpiece. Upon detection of a short circuit, the controller starts a timer, and enables the power circuit to provide a steady state, or DC, flow of output current to the power output for a predetermined time period to heat both the electrode and the workpiece to lower the start current needed to form the welding arc. The time period may vary depending on the electrode and the workpiece being used.

### FIELD OF THE INVENTION

The present invention relates generally to devices used to weld metal using electrical current. The present invention is more particularly, though not exclusively, an apparatus and method or establishing an arc in an arc-welding process using a pre-heating current.

### BACKGROUND OF THE INVENTION

Various methods are used for attaching one metal object to another. One such method is the welding of those metal objects together. There are several techniques for welding devices together, including for example, gas welding, brazing, Gas Metal Arc Welding (GMAW) also known as Metal Inert Gas (MIG) welding, Gas-Tungsten-Arc welding (GTAW) or often called Tungsten Inert Gas (TIG) welding, and shielded metal arc welding also known as stick welding.

Arc welding involves the use of the concentrated heat of an electrical arc to join metal by fusion of a parent metal, or workpiece, and an additional metal, such as a consumable electrode, or welding rod. The electrical arc is formed by establishing either a direct or alternating current between the workpiece and the welding rod, and the current source must have both transient and static volt-ampere characteristics designed for arc stability and weld performance.

There are three basic welding methods, namely, manual, semiautomatic, and automatic. Manual welding is the oldest method, and is still used today. However, semiautomatic welding has become the most widely used welding method and involves a long, thin electrode which the welding operator manually positions and advances along the weld joint. The consumable electrode may be motor-driven at a preselected speed through the nozzle of a hand-held welding gun or torch.

Automatic welding is similar to the semi-automatic method, except that the electrode is automatically positioned and advanced along a weld joint through motion control devices. Alternatively, the workpiece may be automatically positioned below the welding electrode.

Common with most arc-welding methods is the need for establishing a shielding atmosphere in which to form the welding arc. This shielding atmosphere is formed by the introduction of a continuous stream of inert gas into the area surrounding the welding joint. This inert gas, often argon, helium or a combination thereof, is introduced around the electrode, and forms a shielding atmosphere.

Arc welding is a very effective method of attaching metal pieces together. However, some methods of starting a welding arc using a non-consumable electrode often result in a weld joint that contains impurities deposited from the non-consumable electrode. These impurities are often released from the arc welding electrode and embedded into the workpiece or resulting weld due to the high voltages and currents necessary to initiate the arc welding process. The presence of such impurities often results in a weld joint having decreased strength.

GTAW, or TIG welding, does not use a consumable electrode. Rather, the GTAW process provides heat for the use of joining the material being welded. Typically, a filler metal is used to form the weld, and is the same or similar to the metal being welded. However, in some instances, a filler metal different than the metal being welded is used. Although a filler metal is used, traditional GTAW or TIG welding techniques nevertheless use high frequency currents to initiate the welding arc.

Establishing the arc using high frequencies can cause electrical interference, such as electromagnetic noise, which can affect nearby equipment. The present invention reduces and may eliminate the need for high frequencies and high voltages in order to start the arc process.

U.S. Pat. No. 6,034,350 which issued Mar. 7, 2000, for an invention entitled “Method and Apparatus for Initiating a Welding Arc Using a Background Circuit” (“the '350 patent) describes an apparatus and method for initiating an arc welding process. The device described in the '350 patent provides a power circuit that generates an output current that creates an arc between an electrode and a workpiece after a short circuit has been removed. However, the device of the '350 patent does not provide for the automated initiation of an arc using low currents and voltages. Instead, the '350 patent describes a sequence where the background circuit is on prior to establishing a short circuit.

Conventional arc starting in Gas Tungsten Arc Welding (GTAW), or “TIG” welding, whether welding in the Direct Current (DC) Electrode Negative (EN) mode (the normal mode for work on ferrous metal) or the Alternating Current (AC) mode (the normal mode for work on aluminum material), the current must flow from the tungsten to the work piece.

Inconsistent arc starts are mainly a result of the process not overcoming the resistance of the Tungsten. The current which must pass from the tungsten to the work piece must heat the tungsten to enable the tungsten to become a better emitter of electrons, thus allowing the arc to start easier. Once heated, the arc can jump from the tungsten to the work piece more consistently.

A traditional means of “solving” DC arc starting problems, and the standard method for improving AC arc starts, involves superimposing a high frequency (HF) current over the welding current. Basically, the HF current forms a path for the welding current to follow and so the arc can be established. Unfortunately, HF interferes with CNC machines, computers and other electronic equipment because the frequency of the HF current is similar to a radio's frequency and can be “broadcasted” from the welding device.

A burst of HF current is used to start an arc in DC TIG welding applications (for AC TIG applications, the HF is on continuous to minimize arc outages as the AC welding current passes through the zero crossing). Once the machine has sensed an arc in DC welding, the power supply in the welding unit turns off the HF to minimize any potential interference to electronic equipment.

While arc welding is generally described above, the present invention is particularly, though not exclusively, useful in a GTAW or TIG welding process. In light of the above, it would be advantageous to provide a GTAW or TIG welding device that provides reliable arc starting of an automated system without using high frequency, high voltage, and without adding impurities into the material. It would also be advantageous to provide an arc welding device that does not require the high voltages to initiate the arc welding process.

### SUMMARY OF THE INVENTION

The present in invention incorporates the use of power sources utilizing a background current to start the arc. This process is similar to “Scratch Start.” Scratch starting a TIG arc may contaminate the weld with tungsten, because of the higher amperages it uses to start the arc, depositing or breaking off part of the tungsten in this process. Using a background current to start the arc, a small current is used to preheat the tungsten in order for it to become a better emitter. Once the tungsten is sufficiently heated, the tungsten can be retracted from the work piece and welding current can begin flowing with no work piece tungsten contamination.

The present invention includes an apparatus for initiating a welding arc during a lift-start welding process. The apparatus includes a power circuit to provide a welding power to a power output, a background circuit to provide a background power to the power output to maintain the welding arc during low power welding processes, and a controller. The background circuit is enabled prior to drawing the welding arc, thus providing a background voltage to the power output of the welding device. The background voltage is monitored such that the controller can detect when the servo/controller has touched the electrode to the workpiece.

Upon detection of a short circuit, the controller enables the power circuit to provide a steady state, or DC, flow of output current to the power output. This output current serves as a heating current to heat both the electrode and the workpiece in order to lower the start current needed to start the welding arc thereby minimizing any electrode material, such as tungsten, being lodged into the weld or workpiece. The period of time for the heating current may vary depending on, for example, the thickness and type of material being welded, and the thickness and type of electrode. Also, the steady-state heating current eliminates the need for high frequency impulses to initiate the welding process.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram of a welding system of the present invention, including a welding apparatus with a motion control device for positioning an electrode over a weld joint on a workpiece, and a controller providing monitoring and control functions for the motion control device and power supply;

FIG. 2 is a flow chart showing the operation of the present invention including a short-circuit detector for establishing a heating current between the electrode and the workpiece to facilitate the start of the arc-welding process; and

FIG. 3 is a timing diagram showing the relative timing between the motion control device, the gas pre-flow to form the shielding atmosphere, the heating current, and the voltage and current supplied from the power supply, and the variable timing periods for providing a heating current that may vary depending on the materials used in the welding process.

### DETAILED DESCRIPTION OF A PREFERRED EMBODIMENT

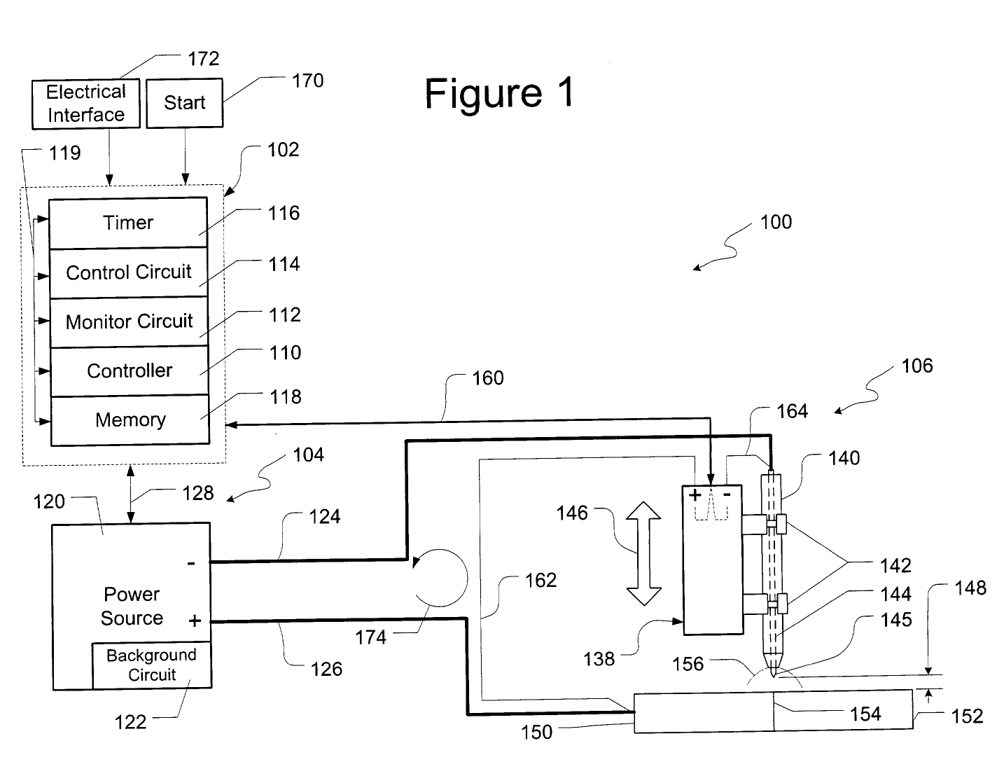

Referring initially to FIG. 1, a block diagram of a welding system of the present invention is shown and generally designated 100. System 100 includes a power control system 102 providing control signals to a power supply 104, and a welding device 106.

Power control system 102 includes a controller 110, monitor circuitry 112, control circuitry 114, timer 116, and a memory 118. While FIG. 1 depicts timer 116, control circuit 114, monitor circuit 112, controller 110 and memory 118 to have a particular arrangement in power control system 102, such placement is merely exemplary of a preferred embodiment and does not denote any specific electrical connection, rather, all components are in electrical communication to each other via electrical interconnect 119.

Controller 110 includes a microprocessor, microcontroller, or other digital control apparatus, and provides an operational control function for system 100, and more specifically, receives information from other components of the welding system 100 and generates electronic signals for transmitting to other components of the welding system 100 to accomplish the desired welding process.

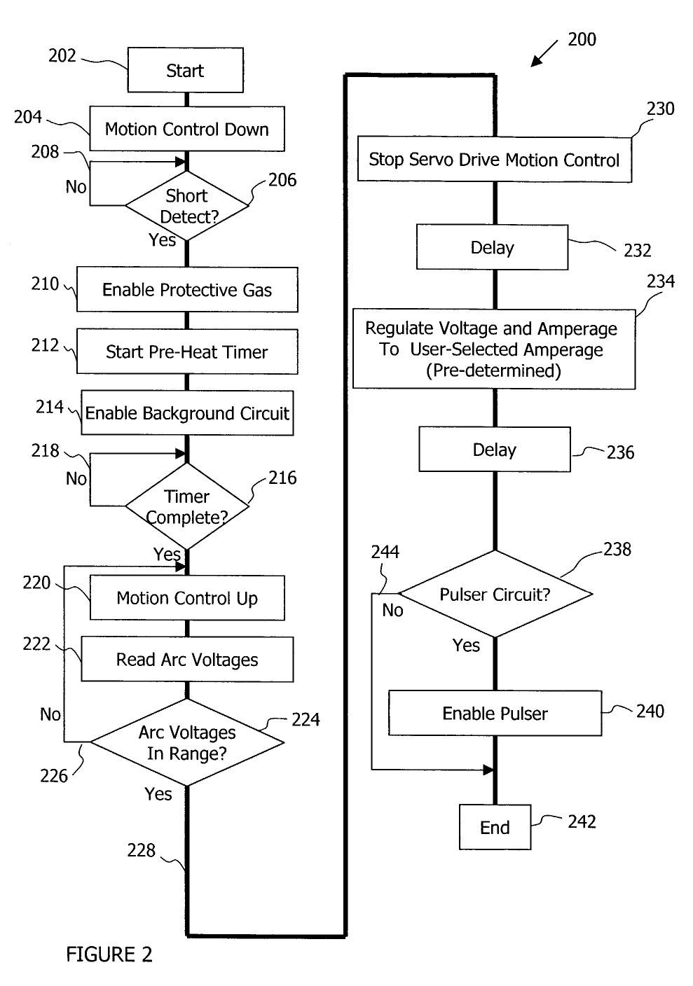

As will be discussed in greater detail below in conjunction with FIG. 2, timer 116 provides a timing delay function for a welding operation, and the particular timing delays may be determined by the user of the welding equipment, or may be preselected, or a combination of the user selection from a preselected set of timing features. In a preferred embodiment, memory 118 may be pre-programmed with a family of delay periods or timer intervals for a pre-heating current that may be different depending upon the type and thickness of the materials being welded together.

Power source 120 provides upon command an electrical welding signal which includes the necessary output voltage and current to perform the joining of metals, e.g. welding. Power source 120 further includes a background circuit 122 that senses the voltage between the welding electrode 144 and the workpiece 150 and 152, and provides the background current used in the lift-start process.

The electrical welding signal is provided to the welding device via negative power lead 124 and positive power lead 126. As shown in FIG. 1, negative and positive power leads 124 and 126 attach to welding device 106. Electrical connection 128 interfaces power control system 102 to power supply 104 through which power control system 102 provides control signals to power supply 104 to generate the particular voltage and amperage necessary for the welding operation.

Welding device 106 includes a motion control device 138 having a welding electrode sleeve 140 attached to the motion control device with electrode brackets 142. A welding electrode 144 is sized to be received within electrode sleeve 140 and secured with electrode brackets 142 so only a small portion of the tip 145 protrudes from electrode sleeve 140.

Motion control device 138 is capable of moving electrode sleeve 140 in an up/down direction 146 such that tip 145 is separated from workpieces 150 and 152 a distance, or arc gap, 148, and directly above joint 154. In a preferred embodiment, motion control device includes a servo mechanism suitable for the vertical translation of the electrode brackets 142, however, other mechanical motion devices known in the art are suitable.

A shielding atmosphere 156 is formed around tip 145 and over joint 154 of workpieces 150 and 152. More specifically, to form shielding atmosphere 156, an inert gas passes through sleeve 140 and along electrode 144 to form a shielding atmosphere 156. Inert gases that are typically used in such applications include, but are not limited to, argon and helium. Atmosphere 156 provides for a substantially oxygen-free environment for the establishment of a welding arc.

Motion control and voltage sensing lead 160 provides an electrical connection between welding device 106 and power control system 102. More specifically, positive voltage sense lead 162 and negative voltage sense lead 164 are in electrical connection with motion control and voltage sensing lead 160. Positive voltage sense lead 162 is electrically connected to the conductive workpiece, or workpiece table (not shown). Negative voltage sense lead 164 is electrically connected, either directly or through a conductive portion of the welding device, to the welding electrode 144.

In use, when motion control device 138 moves motion control sleeve 140 and welding electrode 144 in direction 146 toward workpieces 150 and 152, a short circuit between positive voltage sense lead 162 and negative voltage sense lead 164 will occur when distance 148 is decreased to zero, namely, when welding electrode 144 comes in contact with workpieces 150 and 152. Monitor circuitry 112 receives electronic signals from motion control and voltage sensing lead 160 and determines when a short circuit exists between welding electrode 144 and workpieces 150 and 152.

Referring now to FIG. 2, the operation and process of the present invention is shown using a flow chart generally designated 200, and discussed in conjunction with FIG. 1. Flow chart 200 starts at step 202, such as with the pressing of a start button 170, or by receipt of start command via an electronic interface 172. Once started, the process continues in step 204 with the downward movement of electrode 144 in direction 146. The downward motion of electrode 144 continues until a short circuit is detected in step 206 when welding electrode 144 comes in contact with the workpiece 150 and 152. More specifically, monitor circuit 112 provides a sensing voltage, typically less than 3.2 volts DC with a low current limit, to positive and negative voltage sense leads 162 and 164. As long as a voltage exists between the positive and negative voltage sense leads 162 and 164, an open circuit exists and the downward motion of motion control device 138 continues through return path 208. However, when motion control device 138 lowers welding electrode 144 sufficiently in direction 146 to contact workpiece 150 and 152, this voltage becomes zero.

Once a short circuit is detected in step 206, a protective gas begins to flow in step 210. This protective gas provides for the shielding atmosphere 156 shown in FIG. 1. This shielding atmosphere provides for an oxygen-free welding environment yielding a weld having fewer defects.

A pre-heat timer is started in step 212. The pre-heat timer is maintained in timer 116 of power control system 102. In a preferred embodiment, timer 116 may be implemented as a digital count-down timer or clock cycle counter, or any other method known in the art, to establish a time interval.

The power control system 102 generates in step 214 an enable background circuit signal that is communicated to power source 120 via electrical connection 128. The enable background circuit signal activates background circuit 122 in power supply 104 which generates a heating current that is supplied to the negative and positive power lead 124 and 126. This heating current passes in direction 174 through workpiece 150 and 152, and through welding electrode 144 primarily to heat the welding electrode 144, and to a lesser degree, to heat workpiece 150 and 152.

While steps 210, 212 and 214 have been depicted to have a particular order, namely step 210 prior to step 212 prior to step 214, this order is merely exemplary of a preferred embodiment of the present invention. It is to be appreciated that the starting of the pre-heat timer and protective gas may occur prior to the enabling of the background circuit, after the enabling of the background circuit, or simultaneously therewith.

The pre-heat timer is monitored in step 216 and the protective gas and heating currents are maintained through path 218 so long as the pre-heat timer has not expired. During the pre-heat timing period, the electrode 144 is short-circuited to the workpiece 150 and 152, and thus the voltage between the workpiece and the electrode is zero, with the heating current passing through the electrode providing a heating current. Typically, this heating current may be 20 amperes, but other current levels may be used.

Table 1 below provides guidance in the selection of an appropriate pre-heat timer duration. As shown below, the pre-heat timer increases with an increased thickness of the workpiece material. In one application where welding ⅛ inch material, a pre-heat timer setting may be 0.8 seconds, and with a thicker material of ½ inch, the pre-heat timer setting may be one second.

TABLE 1
Minimum Pre-Heat Times for Reliable Lift-Start Arc Starting

| | Tungsten Pre-Heat | True Tungsten Pre-Heat |
|---|---|---|
| Material Thickness | Timer Setting* | Time (seconds) |
| (inches) | (seconds) | (less pre-purge time) |
| ⅛ | 0.8 | 0.5 |
| ¼ | 0.9 | 0.6 |
| ½ | 1.0 | 0.7 |

The testing configuration for an arc starting process described above in Table 1 includes a 5/32 Tungsten Electrode with 100 Ampere Preset for desired welding level. No sloping of the welding amperage was selected, and no initial sequences were selected (i.e. initial Amperes after arc started, etc.). The Pre-Purge was set at a minimum level on the power source, namely 0.3 seconds. The timer setting includes the minimum Gas Pre-Purge time on the power source of 0.3 seconds, thus, the true tungsten Pre-Heat time is 0.3 seconds less than the timer setting. Further preliminary testing with smaller diameter electrodes required less pre-heat time than larger diameter electrodes.

Once timer is completed in step 216, motion control device 138 translates welding electrode 144 upwards in direction 146 in step 220. As welding electrode 144 separates from workpiece 150 and 152, power source 120 generates arc voltages due to the open circuit being created between welding electrode 144 and workpiece 150 and 152. The arc voltages are monitored in step 222 within power source 120 and in power control system 102. The arc voltages measured in step 222 are compared in step 224 to a range of acceptable arc voltages within the power control system 102.

In the event the arc voltages are not within a predetermined range as measured in step 222, return path 226 provides for the continued upward translation of the motion control device 138 and welding electrode 144 in direction 146 in step 220, and the arc voltages are again measured in step 222 and compared to the range of acceptable arc voltages in step 224. Suitable arc welding voltages depend on many factors that one skilled in the art would consider in selecting the arc welding voltage. Typically, power source 120 is equipped with a welding current selector and power control system 102 is equipped with welding voltage selector that may be adjusted by the user, and may be varied during the welding process to provide the best resultant weld. In a typical application, the arc voltages may range from 5 to 50 volts, but other voltages may be used.

Once the voltages measured in step 222 are within the suitable range, the motion control device 138 is stopped in step 230 and a short delay occurs in step 232. At this point in process 200, a welding arc has been established between welding electrode 144 and workpiece 150 and 152 and the voltage and amperage are regulated in step 234 to provide the user-selected welding current/voltage. In operation, as the motion control device 138 moves the welding electrode 144 up, the voltage increases, and as the motion control device 138 moves the welding electrode 144 down, the voltage decreases.

Following the regulation of the voltage and amperage in step 234, a short delay occurs in step 236, and if a pulser circuit has been selected in step 238, the pulser is enabled in step 240 and process 200 passes to the end of the welding process in step 242. If no pulser circuit has been selected, process 200 passes through path 244 to the end of the welding process in step 242.

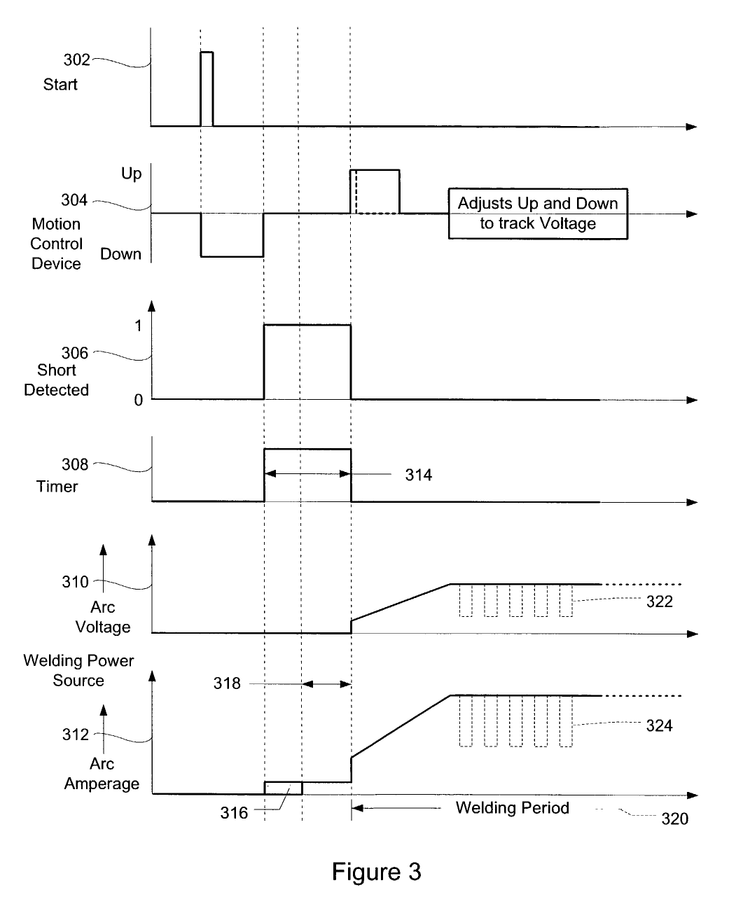

Referring now to FIG. 3, a timing diagram showing the relative timing between the motion control device, the gas pre-flow, the heating current, and the voltage and current supplied from the power supply is shown and generally designated 300. FIG. 3, in conjunction with FIGS. 1 and 2, provides for the relative timing of some steps discussed in conjunction with process 200, and thus, will be described with reference to FIG. 2.

Timing diagram 300 includes six separate information timing traces, namely, start signal trace 302, motion control device trace 304, short detection trace 306, timer trace 308, welding power source arc voltage trace 310 and welding power source arc current trace 312. Start signal trace 302 depicts the start step 202, and in turn begins the downward movement of motion control device 138 in step 204 and motion control trace 304.

Once a short circuit between welding electrode 144 and workpiece 150 and 152 is detected in step 206 and shown in trace 306, timer 116 is started in step 212, shown in trace 308. The duration 314 of timer 116, as depicted in trace 308, may have a variety of time periods. As shown in Table 1, this timer period may change depending on the welding electrode material and diameter, the workpiece material and size/thickness, the relative temperature of the workpiece, AC versus DC welding applications, and other factors.

Prior to or concurrent with the initiation of timer 116 in step 212, the gas to form the shielding atmosphere begins to flow as shown by period 316 in trace 312. This gas pre-flow establishes the shielding atmosphere prior to the energizing of the pre-heat current in order to have an oxygen-free atmosphere.

A heating current is provided during the timer period 314 shown as heating period 318 in trace 312. Typically, this heating current may be 20 amperes, but other current levels may be used. This pre-determined heating period ends upon the completion of timer period 314 in step 216, and motion control device 138 translates welding electrode 144 upwards from workpiece 150 and 152, thereby establishing an arc voltage in trace 310.

Once the arc voltage is established by raising welding electrode 144 from workpiece 150 and 152, the welding period 320 continues for the duration of the welding process as shown in trace 312. During this welding period, pulsing may occur as shown by dashed lines in traces 310 and 312. Pulsing in an arc welding process typically has a fifty percent (50%) duty cycle, but other duty cycles may be implemented.

While the particular method and apparatus for improved lift-start welding as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for initiating an arc weld between a workpiece and a welding electrode, the method comprising the steps of:
establishing a short circuit between a workpiece and a welding electrode;
determining a short circuit time interval for said short circuit;
providing a heating current passing through said workpiece and said welding electrode;
breaking said short circuit when said time interval expires;
establishing an arc gap between said workpiece and said welding rod; and
monitoring said arc voltages and adjusting said arc gap to maintain said arc voltages in a predetermined voltage range.

2. The method of claim 1, wherein said heating current passes through said workpiece and said welding electrode for said time interval.

3. The method of claim 1, wherein said time interval is determined by a user.

4. The method of claim 1, wherein said time interval is determined by a power control system.

5. The method of claim 4, wherein said power control system comprises a memory, and said time interval is retrieved from said memory.

6. The method of claim 5, wherein said memory contains a range of time intervals, and said time interval is selected from said range of time intervals.

7. The method of claim 6, wherein said range of time intervals include 0.5 seconds to 12 seconds.

8. The method of claim 1, wherein said time interval is selected from a range of time intervals.

9. The method of claim 8, wherein said range of time intervals include 0.5 seconds to 12 seconds.

10. An arc welding device, comprising:
a welding electrode operably connected to a means for positioning said electrode from a first position wherein said welding electrode contacts said workpiece to establish a short circuit and a second position wherein said welding electrode is apart from said workpiece to establish an arc gap;
a power source electrically connected to said welding electrode and said workpiece; and
a means for providing a heating current through said workpiece and said welding electrode to pre-heat said welding electrode.

11. The arc welding device of claim 10, wherein said means for providing a heating current further comprises a power control system and wherein said heating current has a duration determined by said timer.

12. The arc welding device of claim 11, wherein said power control system further comprises a memory containing one or more timer intervals and wherein said duration is selected from said timer intervals.

13. The arc welding device of claim 12, wherein said timer intervals range from 0.3 seconds to 3 seconds.

14. The arc welding device of claim 10, further comprising:
a means for determining an arc voltage between said welding electrode and said workpiece; and
a means for maintaining said arc voltage within a predetermined range.

15. The arc welding device of claim 14, wherein said means for positioning said electrode further comprises a motion control device.

16. The arc welding device of claim 14, wherein said means for determining said arc voltage further comprises a power control system, wherein said power control system adjusts said arc voltage and said motion control device to maintain a pre-determined welding voltage.

17. The arc welding device of claim 10, further comprising:
a means for determining an arc current between said welding electrode and said workpiece; and
a means for maintaining said arc current within a predetermined range.

18. The arc welding device of claim 17, wherein said means for determining said arc current further comprises a power source, wherein said power source adjusts said arc current and said motion control device to maintain a pre-determined welding current.

19. The arc welding device of claim 10, further comprising a means for establishing a shielding atmosphere adjacent said welding electrode.

20. The arc welding device of claim 19, wherein said shielding atmosphere comprises an inert gas selected from argon, helium, and a combination thereof.

21. An arc welding device, comprising:
a welding electrode operably connected to a means for positioning said electrode from a first position wherein said welding electrode contacts said workpiece to establish a short circuit and a second position wherein said welding electrode is apart from said workpiece to establish an arc gap; and
a means for providing a heating current through said workpiece and said welding electrode to pre-heat said welding electrode.

22. The arc welding device of claim 21, wherein said means for providing a heating current through said workpiece and said welding electrode further comprises:
a power source electrically connected to said welding electrode and said workpiece; and
a timer having a pre-determined time interval wherein said heating current has a period determined by said time interval.
